(19) United States
(12) Patent Application Publication
(10) Pub. No.: US 2019/0296937 A1
(43) Pub. Date: Sep. 26, 2019

(54) Central Data Store in Vehicle Electrical System

(71) Applicant: Bayerische Motoren Werke Aktiengesellschaft, Muenchen (DE)

(72) Inventors: Andreas KERN, Roth (DE); Thomas KOENIGSEDER, Wilfling (DE); Christoph SCHMUTZLER, Muenchen (DE)

(21) Appl. No.: 16/437,136

(22) Filed: Jun. 11, 2019

Related U.S. Application Data
(63) Continuation of application No. PCT/EP2017/082599, filed on Dec. 13, 2017.

(30) Foreign Application Priority Data
Jan. 10, 2017 (DE) 10 2017 200 263.8

(51) Int. Cl. H04L 12/403; H04L 12/40

(52) U.S. Cl. CPC H04L 12/403; H04L 12/40039; H04L 2012/40234; H04L 2012/40215; H04L 2012/40241; H04L 2012/40273

(57) ABSTRACT

A central gateway controller (100) for managing data which is transmitted via a vehicle electrical system of a vehicle is provided. The gateway controller includes at least one central communication server, ZKS, (110) including at least one central information store, ZIA, (120) for centrally storing data, which is transmitted via the vehicle electrical system, and at least one communication module (130, 132, 134, 136) for transmitting data between the ZIA and at least one bus system (160, 162, 164, 166) belonging to the vehicle electrical system. The gateway controller can store the data transmitted via the communication module in the ZIA in uniform data sets. The gateway controller is thus not just used to route messages between different (message) producers or generators and (message) consumers or loads in the vehicle electrical system but is also capable of storing the data to be exchanged in the ZIA in a uniform format.

### CROSS REFERENCE TO RELATED APPLICATIONS

This application is a continuation of PCT International Application No. PCT/EP2017/082599, filed Dec. 13, 2017, which claims priority under 35 U.S.C. § 119 from German Patent Application No. 10 2017 200 263.8, filed Jan. 10, 2017, the entire disclosures of which are herein expressly incorporated by reference.

### BACKGROUND AND SUMMARY OF THE INVENTION

The present invention relates to a central data store in at least one gateway controller in an on-board electrical system.

Gateway controllers in vehicles are known. Such gateway controllers act as a transparent tunnel that exchanges data between various bus systems or bus connections (e.g., FlexRay (FR), Controller Area Network (CAN), Local Interconnect Network (LIN) and Ethernet) in the vehicle. In modern vehicles, two or more of the abovementioned bus systems are often used, these being networked via gateways.

The configuration of on-board electrical systems—that is to say all electronic components in the respective vehicle taken as a whole (e.g., controllers, sensors, wiring, bus systems, energy stores (accumulators, batteries), generators, on-board power sockets, display elements (e.g., warning and indicator lights), etc.) is normally performed at the time when the vehicle is developed or when its system is designed. This also includes the static assignment of each controller or communication participant to a predefined bus system, and therefore also to an assignment of messages arriving on each defined bus. A precise assignment of the message structure also takes place in the process.

The disadvantage of this is that a subsequent modification of the on-board electrical system configuration for a particular vehicle is connected with considerable extra expenditure. Thus, for example, it is not possible to change an assignment of a controller or other communication participant. A further disadvantage of modern gateways is that they are not able to actively access useful data in the respective messages (also called information below) or able to process the useful data. Changes in the useful data to be sent in individual controllers or integration of new controllers or communication participants in the on-board electrical system are thus possible only with considerable expenditure. Due to this, in the course of further developments of even just a single communication participant in the on-board electrical system, all message receivers always have to be laboriously adapted.

An object of the invention is to provide a solution that avoids the abovementioned disadvantages and thus allows a dynamic on-board electrical system configuration.

This object is achieved according to the invention by the features of the independent claims. Preferred embodiments are the subject matter of the dependent claims.

According to a first aspect of the invention, a central gateway controller for managing data that are transmitted via an on-board electrical system in a vehicle is provided. The gateway controller comprises at least one central communication server, ZKS, or a central communication server entity comprising:
at least one central information store, ZIA, for the central storage of data that are transmitted via the on-board electrical system,
at least one communication module for transmitting data between the ZIA and at least one bus system belonging to the on-board electrical system; wherein the gateway controller is able to store the data transmitted via the communication module in uniform datasets in the ZIA.

The central gateway controller may be a controller that comprises at least one ZKS entity. The ZKS entity is a software module that comprises the ZIA and at least one communication module for transmitting data between the ZIA and at least one bus system belonging to the on-board electrical system. The ZIA is thus a storage area in which data or information that are transmitted via the on-board electrical system in a vehicle are able to be stored in a uniform format. The at least one communication module may in this case access the ZIA in read mode or in write mode. This may be performed via correspondingly defined ZIA interfaces or ZIA APIs.

Advantageously, the gateway controller therefore serves not only to route messages between various (message) producers and (message) consumers in the on-board electrical system, but is rather capable, for the first time, of storing the data to be exchanged in the ZIA in a uniform format. The producers are components or communication participants in the on-board electrical system (e.g., controllers, sensors, display elements, etc.) that generate particular datasets, and consumers are components or communication participants in the on-board electrical system that consume at least useful data of particular datasets.

Since the data in the ZIA are stored in uniform datasets, the useful data stored in the ZIA are able to be accessed for example via a (partial) software module implemented in the ZKS entity. Furthermore, due to the uniform dataset structure, the stored data are correspondingly able to be processed.

The uniform datasets stored in the ZIA preferably comprise:
a unique identification, ID;
a timestamp;
a version; and/or
useful data or information.

The unique ID is a vehicle-wide unique identification number. The timestamp is a vehicle-wide unique time at which the dataset was generated by a producer. The version is a predetermined, unique version of the useful data or information. The uniform dataset may furthermore have further suitable management information fields.

The uniform datasets stored in the ZIA and useful data present therein are preferably able to be accessed actively and/or the useful data present in the stored datasets are able to be processed.

By way of example, the producers, using correspondingly defined interfaces via communication modules, are able to store useful data or information in the uniform format in the ZIA or access the ZIA in read mode and/or retrieve these or access the ZIA in write mode. In addition, the data read from the ZIA, where necessary, may be further processed by performing calculations about the data or using the data, for example.

The ZIA preferably comprises a working area in which protected, that is to say in particular safety-relevant, data or messages are able to be processed, protected messages comprising:
protocol data units, PDUs, and/or
frames.

The protected messages are what are known as data containers that have end-to-end protection. The end-to-end protection may be implemented by way of a checksum, such as a cyclic redundancy check (CRC). The ZKS thus also allows data storage and data processing of useful data contained in data containers, such that the useful data contained therein are also stored and are able to be accessed and/or are able to be processed. In other words, access to secured communication process chains and therefore also breaking of secured communication process chains is therefore possible.

Preferably, the uniform datasets stored in the ZIA are able to be retrieved and/or processed via corresponding jobs, wherein each job is formed from a sequence of Boolean and mathematical expressions for data querying and/or data processing purposes.

As already mentioned above, various software modules (or modules) may be connected to the ZIA via suitable ZIA interfaces or ZIA APIs. For instance, further software modules, such as for example a job module, may also be connected to the ZIA via a correspondingly suitable ZIA API via the communication modules, which allow a connection of conventional communication systems in the on-board electrical system, such as CAN, FlexRay, Ethernet or LIN via communication controllers. The job module is then able to access the datasets stored in the ZIA and/or process these using jobs. The respective jobs may be stored in the job module. Using jobs, the data stored in the ZIA are thus able to be processed and new data are able to be generated for the ZIA, which data are, for example, required or consumed by consumers.

Jobs may preferably be processed upon the occurrence of at least one predeterminable event and/or cyclically and/or according to need.

A predeterminable or predetermined event may be, for example, a time at which a producer of the on-board electrical system generates data (e.g., speed measurement) and sends them over a predefined bus connection in the on-board electrical system via a communication controller to a communication module, which stores the generated data in the uniform format in the ZIA. Following this storage, the job module is able to access the corresponding dataset via the ZIA API and, for example, perform the calculations (e.g., convert km/h to 100 m/h) defined in the job. The useful data converted in this way may be stored again in the ZIA by the job module via the corresponding ZIA API. Cyclically means that the job is performed by the job module, for example, at predetermined time intervals (e.g., every 10 ms, every 20 ms, every 50 ms, etc.). According to need means that the job is only executed when this is actively requested by another module connected to the ZIA via a suitable ZIA API, for example. Computational and storage capacities are thus advantageously saved, since a job is executed only upon predetermined events or according to need.

The at least one communication module preferably comprises:
at least one Ethernet module for exchanging data between the ZIA and an Ethernet connection; and/or
at least one FlexRay, FR, module for exchanging data between the ZIA and at least one FR bus connection; and/or
at least one Controller Area Network, CAN, module for exchanging data between the ZIA and one or more CAN bus connections; and/or
at least one Local Interconnect Network, LIN, module for exchanging data between the ZIA and one or more LIN bus connections.

As already explained above, various modules may be connected to the ZIA via corresponding ZIA interfaces, by way of which the modules are able to access the ZIA in read mode and/or in write mode. The abovementioned modules (Ethernet, FR, CAN and LIN) may each be software modules encapsulated in the ZKS entity. In this case, the respective modules may first of all each be connected to a corresponding communication controller via suitable interfaces, via which the connection to corresponding communication systems (that is to say CAN bus, FR bus, Ethernet and LIN bus) in the on-board electrical system is created. In one specific example, an FR module may access the ZIA in read mode and/or in write mode via a suitable ZIA API. In addition, the FR module may be connected to a corresponding communication controller that is responsible for exchanging data with a particular FR bus connection. One or more controllers or further communication participants in the on-board electrical system may themselves also be coupled as consumers and/or producers to the FR bus connection. The respective modules thus take over the communication connection of the respective different communication buses, such as CAN, FR, Ethernet and LIN.

The data may be converted into the uniform data format in any suitable way. In the respective on-board electrical system modules (LIN, CAN, FR, ETH), abstraction of the on-board electrical system-specific forms of the information (signals or services) to the uniform form or the uniform data format in the ZIA may take place. By way of example, in the case of CAN, the content of the payload may be identified using the CAN-frame-ID. The contents are then mapped to the respective information in the ZIA. The bus-specific serializations of information or data are also referred to as views of information or data from the ZIA.

The gateway controller preferably additionally comprises at least one storage medium. The ZKS additionally comprises:
a logging module that is able to transmit at least part of one or more corresponding datasets from the ZIA into the storage medium upon the occurrence of at least one predeterminable event and/or cyclically; and/or
a tracing module that is able to transmit at least part of one or more corresponding datasets from the ZIA and optionally additional technical parameters of corresponding or associated data or frames from the at least one communication module into the storage medium upon the occurrence of at least one predeterminable event and/or cyclically.

The logging module may be a further software module encapsulated in the ZKS entity that is connected to the ZIA via a corresponding ZIA API. Upon the occurrence of a predeterminable or predetermined event, the logging module may transmit at least part of one or more corresponding datasets from the ZIA into the storage medium, where these are then able to be stored. The storage medium may be a persistent memory. By way of example, one or more datasets or at least the useful data of the one or more datasets in terms of particular vehicle state information may thus be stored in the persistent memory for later evaluation.

The tracing module may be a further software module encapsulated in the ZKS entity. Upon the occurrence of the predeterminable or predetermined event, the tracing module may additionally transmit at least one or more technical parameters of one or more corresponding datasets or frames from the corresponding communication module or bus module from which the one or more datasets in terms of particular vehicle state information originate into the persistent memory, where these are then stored. The logging module thus takes data from the ZIA, whereas the tracing module is able to extract further data or information or technical parameters, belonging to the respective datasets, from the communication modules or bus modules and transmit them into the persistent memory. Advantageously, errors on the on-board electrical system level are thus able to be located or found.

By way of example, an event recorder or data recorder may thus be implemented in the vehicle.

According to a second aspect, the object is achieved by a method for managing data that are transmitted via an on-board electrical system, comprising:
central storage of data that are transmitted via the on-board electrical system in a central information store, ZIA; wherein the data transmission between the ZIA and at least one bus system belonging to the on-board electrical system takes place via at least one communication module; wherein the data transmitted via the communication module are stored in the ZIA in uniform datasets.

According to a third aspect, the object is achieved by an on-board electrical system for a vehicle, which comprises at least one gateway controller.

These and other objects, features and advantages of the present invention become apparent from studying the following detailed description of preferred embodiments and the appended drawings. Although embodiments are described separately, it is obvious that individual features therefrom may be combined to form additional embodiments.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an exemplary gateway controller.

FIG. 2 shows exemplary uniform datasets as stored in a ZIA entity.

### DETAILED DESCRIPTION OF THE DRAWINGS

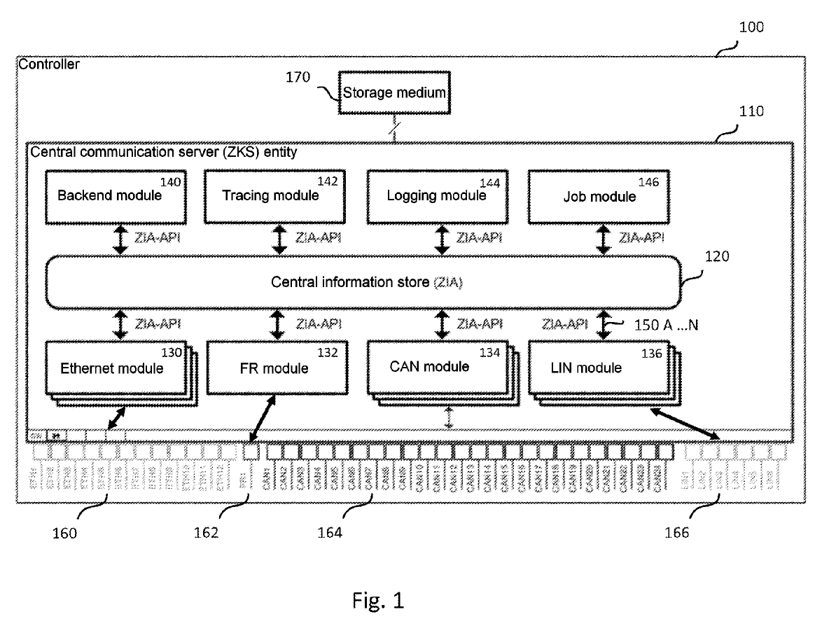

FIG. 1 shows an exemplary gateway controller 100 for managing data that are transmitted via an on-board electrical system in a vehicle, in particular a land vehicle.

The central gateway controller may be a controller that comprises at least one central communication server, ZKS, or a central ZKS entity 110. In other words, even though only one ZKS 110 is shown in FIG. 1 as an example for the sake of simplicity, one or more ZKS entities 110 (hereinafter: ZKS) may be implemented in one or more gateway controllers 100. In the case of a plurality of ZKS entities 110 (which may be instantiated on a plurality of gateway controllers), the individual corresponding ZIAs 120 may each exchange information with one another, so that the uniform datasets 200A . . . N of the respective ZIAs 120 are able to be synchronized with one another. This has the advantage that the data stored in the respective ZIAs are able to be kept redundantly in the vehicle.

It is also possible to provide different scaling levels of one or more ZKS entities in a vehicle, for example, a basic implementation (e.g., just one ZKS 110 with a restricted number of communication modules 130, 132, 134, 136 and further software modules 140, 142, 144, 146 with restricted computational power and restricted memory space) for vehicles with few electronic components, up to providing expansive functions for vehicles with a great number of electronic components. The datasets stored in the ZIA entities may be synchronized with one another (redundant layout in the vehicle). In another example, the ZIAs are not synchronized. Instead of this, the various ZIA entities (or ZIAs) exchange required datasets with one another, where necessary. In other words, any desired number of ZKS entities 110 each having any desired suitable combination of one or more software modules 130, 132, 134, 136, 140, 142, 144, 146 is possible per vehicle. For the sake of clarity, one ZKS entity 110 on one gateway controller 100 is explained with reference to FIG. 1.

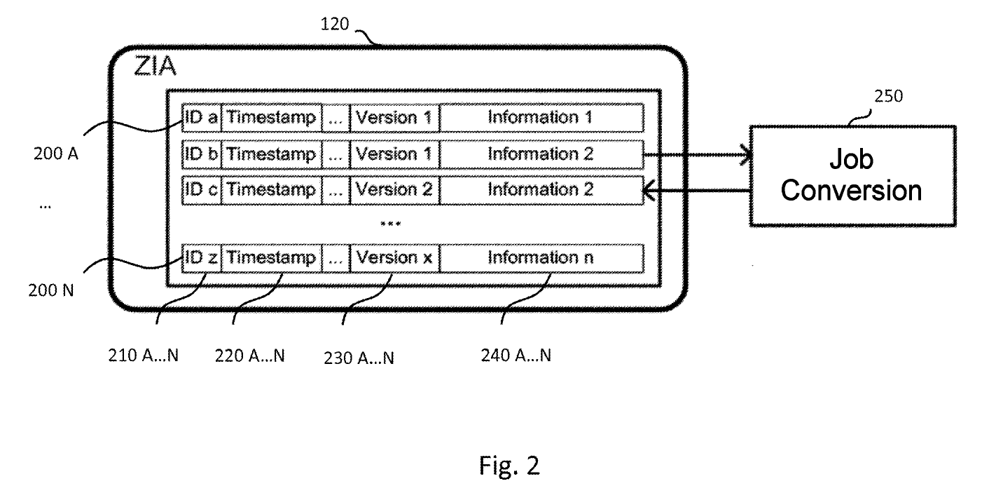

The ZKS 110 (or the ZKS entity 110) is a software module that is instantiated on the gateway controller 100. The ZKS 110 comprises at least one central information store (ZIA) 120 for storing uniform datasets 200A . . . N. Each ZKS 110 comprises at least one further software module, a communication module 130, 132, 134, 136 for transmitting data between the ZIA 120 and at least one communication bus belonging to the on-board electrical system, such as, for example, Controller Area Network (CAN), FlexRay (FR), Ethernet and Local Interconnect Network (LIN). The ZIA 120 is thus a storage area in which datasets 200A . . . N that are sent via an on-board electrical system in a vehicle are able to be stored in a uniform format. The uniform format of the datasets 200A . . . N that are stored on the ZIA is explained further below with reference to FIG. 2.

The at least one communication module 130, 132, 134, 136 may in this case access the ZIA 120 in read mode or in write mode. This may be performed via correspondingly defined, respectively suitable ZIA interfaces or ZIA APIs 150A . . . N. The at least one communication module 130, 132, 134, 136 in the present example comprises:
at least one Ethernet module 130 for exchanging data between the ZIA 120 and at least one Ethernet connection 160;
at least one FlexRay (FR) module 132 for exchanging data between the ZIA 120 and at least one FR bus connection;
at least one Controller Area Network (CAN) module 134 for exchanging data between the ZIA 120 and one or more CAN bus connections; and/or
at least one Local Interconnect Network, LIN, module 136 for exchanging data between the ZIA 120 and one or more LIN bus connections.

As already explained above, various software modules may be connected to the ZIA 120 via corresponding ZIA interfaces or ZIA APIs 150A . . . N, by way of which the modules are able to access the ZIA 120 in read mode and/or in write mode. The abovementioned modules (Ethernet 130, FR 132, CAN 134 and LIN 136) may each be software modules encapsulated in the ZKS entity 110. In this case, the respective communication modules 130, 132, 134, 136 may each first of all be connected to a corresponding communication controller (not shown) via suitable interfaces, via which the connection to corresponding communication buses (that is to say CAN, FR, Ethernet and LIN) over one or more corresponding bus connections 160, 162, 164, 166 in the on-board electrical system is created. In one specific example, an FR module 132 may access the ZIA 120 in read mode and/or in write mode via a suitable ZIA API 150A . . . N. In addition, the FR module 132 may be connected to a corresponding communication controller (not shown) that is responsible for exchanging data with a particular FR bus connection 162. One or more controllers or further communication participants in the on-board electrical system of the vehicle may themselves also be coupled as consumers and/or producers to the FR bus connection 162. The same applies for the one or more other communication modules 130, 134, 136.

As already mentioned above, the communication modules 130, 132, 134, 136 may access the ZIA 120 in read mode or in write mode via corresponding, suitable ZIA APIs 150A . . . N. In this case, each ZIA API 150A . . . N is a defined, suitable ZIA interface 150A . . . N, via which the corresponding communication modules 130, 132, 134, 136 are able to access datasets 200A . . . N that are stored on the ZIA 120 in read mode or are able to write datasets 200A . . . N on or to the ZIA 120. The respective communication modules 130, 132, 134, 136 thus take over the communication connection of the respective various communication buses, such as CAN, FR, Ethernet and LIN.

The gateway controller 100 may furthermore additionally comprise at least one storage medium 170. The ZKS entity 110 may furthermore comprise a logging module 144 that is able to transmit at least part of one or more corresponding datasets 200A . . . N from the ZIA into the storage medium 170 upon the occurrence of at least one predeterminable event and/or cyclically. The logging module 144 may be a further software module encapsulated in the ZKS entity 110 that may be connected to the ZIA 120 via a corresponding ZIA API 150A . . . N. Upon the occurrence of a predeterminable or predetermined event, the logging module 144 may transmit at least part of one or more corresponding datasets 200A . . . N from the ZIA 120 into the storage medium 170, where these are then able to be stored. The storage medium 170 may be a persistent memory. By way of example, one or more datasets 200A . . . N or at least the useful data 240A . . . N of the one or more datasets 200A . . . N in terms of particular suitable vehicle state information may thus be stored in the persistent memory 170 for later evaluation.

The ZKS may furthermore comprise a tracing module 142 that is able to transmit at least part of one or more corresponding datasets 200A . . . N from the ZIA 120 into the storage medium 170 upon the occurrence of at least one predeterminable event and/or cyclically. The tracing module 142 may be a further software module encapsulated in the ZKS entity 110. Upon the occurrence of a predeterminable or predetermined event, the tracing module 142 may transmit at least part of one or more corresponding datasets 200A . . . N from the ZIA 120 into the persistent memory 170, where these are then able to be stored. By way of example, an event recorder or data recorder may thus be implemented in the vehicle via the gateway controller 100. The tracing module 142 may be a further software module encapsulated in the ZKS entity. Upon the occurrence of the predeterminable or predetermined event, the tracing module 142 may additionally transmit at least one technical parameter or further relevant data or information from the associated communication module or bus module 130, 132, 134, 136 into the persistent memory 170, where these are then able to be stored. The logging module 144 thus takes data from the ZIA 120, whereas the tracing module 142 is furthermore able to extract further data or information or technical parameters, belonging to the respective datasets 200A . . . N, from the corresponding communication modules or bus modules 130, 132, 134, 136 and transmit them into the persistent memory 170. Advantageously, errors on the on-board electrical system level are thus able to be located or found.

Advantageously, the gateway controller 100 therefore serves not only to route messages between various (message) producers and (message) consumers in the on-board electrical system, but is rather capable, for the first time, of storing the data to be exchanged in the ZIA 120 via uniform datasets 200A . . . N. As already explained above, producers are components or communication participants in the on-board electrical system (e.g., controllers, sensors, display elements, etc.) that generate particular data or datasets, and consumers are components or communication participants in the on-board electrical system that consume at least useful data from producers. Since the data in the ZIA 120 are stored in uniform datasets 200A . . . N, the gateway controller 100 is for example able to access the datasets 200A . . . N stored in the ZIA 120 and therefore in particular the useful data or information 240A . . . N via a (partial) software module implemented in the ZKS entity 110. Furthermore, the gateway controller 100, due to the uniform dataset structure of the datasets 200A . . . N, is able to extract therefrom and accordingly process at least their useful data 240A . . . N.

Preferably, the uniform datasets 200A . . . N stored in the ZIA 120 and useful data or information 240A . . . N present therein are thus able to be accessed actively via the corresponding ZIA APIs 150A . . . N. As a result, the useful data 240A . . . N present in the stored datasets 240A . . . N are also able to be further processed, as described in more detail below with reference to the job module 146. In particular, the producers in the on-board electrical system, using correspondingly defined interfaces to communication controllers, are able to store the captured data in the uniform format in the ZIA 120 via communication modules 130, 132, 134, 136.

The ZIA 120 may furthermore comprise a working area (not shown) in which messages protected in the ZIA 120 are able to be processed. Protected messages may be for example protocol data units, PDUs, and/or frames. The protected messages are in particular what are known as data containers that have end-to-end protection. The end-to-end protection may be implemented by way of a checksum, for example, cyclic redundancy check (CRC) and/or alive counter. The ZKS thus also allows data storage and data processing of datasets contained in data containers, such that datasets, contained in the data containers, in the ZIA 210 are also able to be stored in uniform datasets (200A . . . N). Consumers are thus also able to access these data and/or process them.

The ZKS entity may furthermore comprise a job module 146. The job module 146 may be a software module that is able to access the datasets 200A . . . N stored in the ZIA 120 via corresponding jobs and/or process them via a suitable ZIA API 150A . . . N. Each job may be formed from a sequence of Boolean and mathematical expressions for data querying and/or data processing purposes. As already mentioned above, various software modules (or modules) may be connected to the ZIA via suitable ZIA interfaces or ZIA APIs 150A . . . N. Thus, via the communication modules that allow a connection of conventional communication systems in the on-board electrical system, such as CAN, FlexRay, Ethernet or LIN via communication controllers, it is also possible to connect further modules, such as for example the job module 146, to the ZIA via a correspondingly suitable ZIA API 150A . . . N. The job module 146 may then access the datasets 200A . . . N stored in the ZIA and/or process them using jobs.

Jobs may preferably be processed in this case upon the occurrence of at least one predeterminable event and/or cyclically and/or according to need. A predeterminable or predetermined event may be, for example, a time at which a producer of the on-board electrical system generates data (for example speed measurement) and sends them over a predefined bus connection 160, 162, 164, 166 in the on-board electrical system via a correspondingly connected communication controller to a communication module 130, 132, 134, 136, which stores the generated data in the uniform format as a uniform dataset 200A . . . N in the ZIA 120. Following this storage, the job module 146 is able to access the corresponding dataset 200A . . . N via the ZIA API 150A . . . N and, for example, perform the calculations (e.g., convert km/h to 100 m/h) defined in the job. The useful data converted in this way may be stored again in the ZIA 120 by the job module via the corresponding ZIA API 150A . . . N. Cyclically means that the corresponding job is performed by the job module 146 for example at predetermined time intervals (e.g., every 10 ms, every 20 ms, every 50 ms, etc.). According to need means that the corresponding job is only executed when this is actively requested for example by another module connected to the ZIA 120 via a suitable ZIA API 150A . . . N. Advantageously, computational and storage capacities are thus minimized, since a job is only executed upon predetermined events or according to need.

The ZKS entity 110 may furthermore comprise a back-end module 140 that is able to access the ZIA 120 in read mode and/or in write mode via a suitable ZIA API 150A . . . N. The ZIA 120 may be connected to a vehicle-external network (back-end communication) via the back-end module 140. By way of example, one or more back-end servers may access the back-end module 140 in write mode if a producer is not able to supply useful data 240A . . . N required by a consumer. By way of example, in the case of vehicles that support at least an at least partly autonomous driving mode, it may be necessary for a producer, for example a camera installed in the vehicle, to recognize road signs relating to the current maximum speed limit and to make this accessible to a consumer, for example, an automatic speed controller in the vehicle, via the ZIA 120, in a uniform dataset. If the producer—that is to say the camera—is however not able to recognize the permitted maximum speed on a sign, the current permitted maximum speed may be retrieved by a back-end server (not shown) via the back-end module 140 and be stored on the ZIA 120 via the corresponding ZIA API 150A . . . N and thus be made available to the consumer.

FIG. 2 shows uniform datasets 200A . . . N that are able to be stored in the ZIA 120, as described with reference to FIG. 1. In this case, each of the stored datasets 200A . . . N may comprise a unique identification, ID, 210A . . . N. The unique ID 210A . . . N may be a vehicle-wide unique identification number. In addition or as an alternative thereto, each dataset 200A . . . N may comprise a timestamp 220A . . . N. The timestamp 220A . . . N may be a vehicle-wide unique time at which the corresponding data were generated by a producer. In addition or as an alternative thereto, each dataset 200A . . . N may comprise a unique version 230A . . . N. The version 230A . . . N is a predetermined, unique version of the useful data or information 240A . . . N. In addition, each dataset 200A . . . N may comprise useful data or information 240A . . . N.

Using the gateway controller 100, the on-board electrical system is able to be configured at the time of development, at which the filling of the ZIA is initially able to be defined. In other words, it is possible to define the assignment of data, arriving on predefined buses, from predefined producers, of the identification of the message via a frame ID or identifiers contained in the useful data to specific information created by predetermined communication participants. A dynamic on-board electrical system configuration has furthermore however also taken place. By way of example, a new version of a controller that is responsible for measuring the current speed in the vehicle may be inserted. In this example, an old, current version of the controller may detect the speed with an accuracy of km/h. The new version of the controller may detect the speed with an accuracy of 100 m/h. The new version of the controller is able to be inserted by storing the data that are generated under the same ID, but with a corresponding unique version 230A . . . N (e.g., old device version 1, new device version 2). Furthermore, a job may be stored in the job module 146, which job performs conversion from the data of the new version (in 100 m/h) into data of the old version (km/h). The data converted in this way may accordingly be stored in this version in the ZIA 120 and/or sent directly to the corresponding consumers. This may be necessary for consumers that are only able to further process data in km/h (e.g., require a value in km/h as input in order to calculate the average speed). An assignment of which producers produce data in which version and which consumers consume data in which version may in this case be stored in a persistent memory in the ZKS entity 110 or in the controller 100. The assignment of a particular controller or communication participant in the on-board electrical system to a specific bus connection 160, 162, 164, 166 may thus be annulled.

To save storage space in the ZIA 120, the storage of the uniform datasets 200A . . . N may be restricted to the respective most recent dataset in accordance with the vehicle-wide unique timestamp 220A . . . N or have a predefined log (e.g., the last N datasets).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A central gateway controller for managing data that are transmitted via an on-board electrical system, comprising:
at least one central communication server, ZKS, comprising:
at least one central information store, ZIA, for central storage of the data that are transmitted via the on-board electrical system,
at least one communication module for transmitting data between the ZIA and at least one bus system belonging to the on-board electrical system;
wherein the central gateway controller is configured to store the data transmitted via the communication module in uniform datasets in the ZIA.

2. The central gateway controller as claimed in claim 1, wherein the uniform datasets stored in the ZIA comprise at least one of:
a unique identification, ID;
a timestamp;
a version; and
useful data.

3. The central gateway controller as claimed in claim 1, wherein at least one of the following is true:
the uniform datasets stored in the ZIA and useful data present therein are able to be accessed actively, and
the useful data present in the stored datasets are able to be processed.

4. The central gateway controller as claimed in claim 1, wherein the ZIA comprises a working area in which protected messages are able to be processed, wherein the protected messages include at least one of protocol data units and frames.

5. The central gateway controller as claimed in claim 3, wherein the uniform datasets stored in the ZIA are configured to be at least one of retrieved and processed via corresponding jobs, wherein each job is formed from a sequence of Boolean and mathematical expressions for at least one of data querying and data processing purposes.

6. The central gateway controller as claimed in claim 5, wherein the corresponding jobs may be processed upon the occurrence of at least one of a predeterminable event, cyclically, and according to need.

7. The central gateway controller as claimed in claim 1, wherein the at least one communication module comprises at least one of:
at least one Ethernet module for exchanging data between the ZIA and an Ethernet connection;
at least one FlexRay, FR, module for exchanging data between the ZIA and at least one FR bus connection;
at least one Controller Area Network, CAN, module for exchanging data between the ZIA and one or more CAN bus connections; and
at least one Local Interconnect Network, LIN, module for exchanging data between the ZIA and one or more LIN bus connections.

8. The central gateway controller as claimed in claim 1, further comprising:
at least one storage medium;
wherein the ZKS additionally comprises at least one of:
a logging module configured to transmit at least part of one or more corresponding datasets from the ZIA into the storage medium at least one of cyclically and upon occurrence of at least one predeterminable event; and
a tracing module configured to transmit at least part of one or more corresponding datasets from the ZIA into the storage medium and optionally additional technical parameters of corresponding or associated data or frames from the at least one communication module into the storage medium at one of cyclically and upon the occurrence of at least one predeterminable event.

9. A method for data management of data that are transmitted via an on-board electrical system, comprising:
transmitting the data from at least one bus system belonging to the on-board electrical system via at least one communication module to a central information store, ZIA; and
storing the data transmitted via the at least one communication module in the ZIA in uniform datasets.

10. An on-board electrical system for a vehicle comprising at least one central gateway controller as claimed in claim 1.

11. The central gateway controller as claimed in claim 2, wherein at least one of the following is true:
the uniform datasets stored in the ZIA and useful data present therein are able to be accessed actively, and
the useful data present in the stored datasets are able to be processed.

12. The central gateway controller as claimed in claim 2, wherein the ZIA comprises a working area in which protected messages are able to be processed, wherein the protected messages include at least one of protocol data units and frames.

13. The central gateway controller as claimed in claim 3, wherein the ZIA comprises a working area in which protected messages are able to be processed, wherein the protected messages include at least one of protocol data units (PDUs) and frames.

14. The central gateway controller as claimed in claim 4, wherein the uniform datasets stored in the ZIA are configured to be at least one of retrieved and processed via corresponding jobs, wherein each job is formed from a sequence of Boolean and mathematical expressions for at least one of data querying and data processing purposes.

15. The central gateway controller as claimed in claim 2, wherein the at least one communication module comprises at least one of:
at least one Ethernet module for exchanging data between the ZIA and an Ethernet connection;
at least one FlexRay, FR, module for exchanging data between the ZIA and at least one FR bus connection;
at least one Controller Area Network, CAN, module for exchanging data between the ZIA and one or more CAN bus connections; and
at least one Local Interconnect Network, LIN, module for exchanging data between the ZIA and one or more LIN bus connections.

16. The central gateway controller as claimed in claim 3, wherein the at least one communication module comprises at least one of:
at least one Ethernet module for exchanging data between the ZIA and an Ethernet connection;
at least one FlexRay, FR, module for exchanging data between the ZIA and at least one FR bus connection;
at least one Controller Area Network, CAN, module for exchanging data between the ZIA and one or more CAN bus connections; and
at least one Local Interconnect Network, LIN, module for exchanging data between the ZIA and one or more LIN bus connections.

17. The central gateway controller as claimed in claim 4, wherein the at least one communication module comprises at least one of:
at least one Ethernet module for exchanging data between the ZIA and an Ethernet connection;
at least one FlexRay, FR, module for exchanging data between the ZIA and at least one FR bus connection;
at least one Controller Area Network, CAN, module for exchanging data between the ZIA and one or more CAN bus connections; and
at least one Local Interconnect Network, LIN, module for exchanging data between the ZIA and one or more LIN bus connections.

18. The central gateway controller as claimed in claim 2, further comprising:
at least one storage medium;
wherein the ZKS additionally comprises at least one of:
a logging module configured to transmit at least part of one or more corresponding datasets from the ZIA into the storage medium at least one of cyclically and upon occurrence of at least one predeterminable event; and
a tracing module configured to transmit at least part of one or more corresponding datasets from the ZIA into the storage medium and optionally additional technical parameters of corresponding or associated data or frames from the at least one communication module into the storage medium at one of cyclically and upon the occurrence of at least one predeterminable event.

19. The central gateway controller as claimed in claim 3, further comprising:
at least one storage medium;
wherein the ZKS additionally comprises at least one of:
a logging module configured to transmit at least part of one or more corresponding datasets from the ZIA into the storage medium at least one of cyclically and upon occurrence of at least one predeterminable event; and
a tracing module configured to transmit at least part of one or more corresponding datasets from the ZIA into the storage medium and optionally additional technical parameters of corresponding or associated data or frames from the at least one communication module into the storage medium at one of cyclically and upon the occurrence of at least one predeterminable event.

20. The central gateway controller as claimed in claim 4, further comprising:
at least one storage medium;
wherein the ZKS additionally comprises at least one of:
a logging module configured to transmit at least part of one or more corresponding datasets from the ZIA into the storage medium at least one of cyclically and upon occurrence of at least one predeterminable event; and
a tracing module configured to transmit at least part of one or more corresponding datasets from the ZIA into the storage medium and optionally additional technical parameters of corresponding or associated data or frames from the at least one communication module into the storage medium at one of cyclically and upon the occurrence of at least one predeterminable event.
